(19) United States
(12) Patent Application Publication
(10) Pub. No.: US 2008/0288893 A1
(43) Pub. Date: Nov. 20, 2008

(54) Method and Device for Visualization of Information

(75) Inventors: Erwin Nikkels, Egmond Aan Zee (NL); Qyan Tabak, Huizen (NL)

Correspondence Address: THE WEBB LAW FIRM, P.C., 700 KOPPERS BUILDING, 436 SEVENTH AVENUE, PITTSBURGH, PA, 15219, US

(73) Assignee: GLOBE ASSISTANT B.V., Egmond Aan Zee (NL)

(21) Appl. No.: 12/063,617

(22) PCT Filed: Aug. 11, 2006
(86) PCT No.: PCT/NL06/00418

§ 371 Date: Jun. 30, 2008

(30) Foreign Application Priority Data
Aug. 12, 2005 (NL) 1029724

(51) Int. Cl. G06F 3/048; G06F 17/30

(52) U.S. Cl. 715/848

(57) ABSTRACT

The invention relates to a method of visualizing information about objects for the benefit of a user. The method comprises providing a substantially 2-D space with a plurality of separate locations; providing a set of objects with a plurality of objects; linking each of the objects in the 2-D space to an associated location in the 2-D space; and representing a 3-D virtual environment which is defined by the 2-D space; and at least accentuating and representing objects on the basis of altitudes in the 3-D virtual environment relative to the 2-D space.

The present invention relates to the ordering, sorting, filtering, making available and/or representing or presenting and/or storing of data. It relates in particular to data concerning or about objects from a set of objects. The method can for instance, though not exclusively, be provided or executed as service on the Internet, or in combination with another large set of object data. The invention further relates to devices, software and data carriers which are associated with realization of the method.

In search engines for making information or data available use is made nowadays of search terms to be entered by users for the purpose of finding objects with features or properties related to the search terms. The objects are then hopefully found using usually textual searches on search engines or via links. As a result of the increasingly overwhelming amounts of objects and information about them in environments such as the Internet, there is a reduced chance of a user actually also finding the sought-after information by this means.

It is anticipated that, in the future, the majority of data in such environments, such as the Internet, will be made available or made accessible using graphic environments.

A large part of data sought on the Internet (or other, usually large-scale data sets) depends in some way on the (geographical) location to which these data relate, or at least on a two-dimensional space with for instance coordinates for the purpose of localizing the objects. Data concerning a person, company, house, holiday destination or a determined news report can for instance be related to a geographical location on earth. Every location can be represented in unique manner by a combination of the degree of longitude and the degree of latitude. The earth can in fact thus be divided into an almost infinite number of pairs of coordinates.

It is expected that the Internet will be made available to an increasing extent using graphic aids such as for instance a graphic representation of the globe, where it is possible to zoom into any desired location.

For making available or localizing data on the Internet hardly any use, or none at all, is currently being made of locations associated with the data. Attempts to do so also fail due to the still overwhelming quantities of objects and associated information on offer.

Because the presentation space is limited in a graphically oriented environment by the dimensions of the screen and the resolution used, a cluttered presentation of too many objects could result in great confusion without an (additional) form of preferably processing and filtering. Important information can thus be overlooked.

Filtering in the traditional, often text-based manner (such as search engines where a filtering is applied by entering one or more search terms) is not desirable in a graphically oriented environment. The user will wish to be informed about relevant information in the (virtual) object set, such as the Internet or other large set of objects, preferably without or with the least possible input of text or search terms.

The present invention has for its object to provide in particular an improvement relative to the known art, for which purpose a method is provided as according to the single main claim no. 1 of the appended set of claims.

In order to improve the search functions, or at least the accessibility, of information about or concerning objects from a set of objects, the data are herein processed and representations of objects are selected, modified or adjusted on the basis of such processing.

The method proposed here makes available a plurality of options with which the overview and the searchability of sets of objects, such as the Internet, become or remain good, and the amount of (textual) input required of a user can be limited or even minimized.

It is possible to realize that the user is already presented with pre-filtered information on the basis of a previously entered interest profile. An example of such a system is for instance the ‘Personal GlobeAssistant’ realized by the inventor, in which a person can indicate, among other things, whether he/she wishes to see local or international reports, real estate, travel, etcetera. The user can further also provide textual input in order to set up a relatively new search operation.

The present invention is based on and relates to a mechanism which can be denoted as “Altitude Ranking”, and this expression will also be used hereinbelow. More and/or less relevant information can hereby be presented to users in a controllable manner.

The relevance of these data can be linked to the virtual height or cruise altitude or viewing altitude above a graphic representation of a set of objects, such as for instance a virtual globe, over which the user can cruise in virtual manner in search of or en route to the virtual representation of specific objects in which he or she is interested.

Diverse criteria can be laid down according to the invention for the “relevance” of the data, which criteria can for instance serve as weighting factors. Such criteria can be entered by or originate from parties having an interest in the objects to be represented, or by or from the user, either in an active manner, or passively on the basis of stored or recorded previous search or surfing behaviour.

The method according to the invention on the basis of the so-called Altitude Ranking mechanism ensures that determined objects become (are made) visible, or not, depending on the ‘altitude’ at which a person is cruising above the 2-D space, for instance in the form of a globe, in the 3D environment. In this manner a natural selection can be made, for instance depending on the interest pattern of the searcher or the commercial motives of an information provider. Filtering of data can therefore take place not only on the basis of a 2-D pair of coordinates in the 2-D space (degree of longitude/degree of latitude) or other features, but also on the basis of the (virtual) cruise altitude.

The invention thus relates particularly to an effective use of the third dimension of altitude above the 2-D space by which the 3D virtual environment is defined. The altitude can be linked to an object. This third dimension is not used to represent the actual altitude of an object, but the relevance of the object in question.

Using the method according to the invention based on so-called Altitude Ranking, an automatic filtering can be applied on the basis of a viewing or cruise altitude taken up by the user in the 3D environment. The space round the earth can be presented as a set of ranges, shells or layers. Depending on the geographical location (x,y) and the height (z) of objects, or the viewing or cruise altitude, a subset of the objects or data is visualized or presented per layer.

In order to ensure that determined objects at a higher level (altitude range/layer/shell) are visualized or presented, two aspects have to be dealt with: a. the visual presentation and b. making the data available.

In respect of the visual presentation it is noted that if the user is located at a determined level/altitude, the correct objects must be presented. On the basis of the viewing or cruise altitude of the user and the relative altitude of the representation of objects after processing of the available information relating thereto, the relevant objects from the shell linked to the cruising altitude can be shown. This can of course differ per user and depend on interest profiles or on a previously visited website (e.g. if a person has visited a house site, he/she wishes to see houses and not camping sites).

In respect of presentation of shown objects within a shell a number of additional considerations are possibly relevant for the method according to the present invention, particularly to the extent it is based on the Altitude Ranking mechanism.

There may be a noticeable object within a shell. If the user has a special interest in a specific object in a range or shell at a cruising or viewing altitude at which the user is (virtually) located at a point in time, a desired form or definition can then be given to this object. This is for instance the case when the user has been to a web site where a specific object has been viewed or described. Depending on the setting, the user can then see the specific environment of this object, wherein the relevant specific object can be made extra-noticeable in the visualization thereof, and thus attracts extra attention. The user has for instance viewed a house on a web site with a number of houses, and the user now wishes to see this house with surroundings on the virtual globe. The house in question is then made extra-distinctive.

Other properties of objects can also be visualized by means of colour, representation or definition. The objects shown in a shell will preferably be presented as recognisably as possible. A colour coding can be used for this purpose, for instance depending on a relevant property of an object (e.g. the price of a house).

The user can also zoom further in on an object. Once an object has been made visible, it is then the intention that the user can retrieve more information about it. The most probable behaviour is that a person will orient him/herself toward the visible object and will zoom further in to a lower level. The object in question will in many cases remain visible up to a lowest level or until the user decides to displace the viewing area (field of view) such that the relevant object falls outside this area. This therefore means that one object can be located in a plurality of shells. It can be the case in one embodiment that the closer the focus of the user, the more objects can become visible per shell. Because the field of view of the user also become smaller, this does not result in a problem for the overall view.

In addition, a further consideration can be that of making the data available. Depending on the type of object, the information or data will be located in a database or, in the case of more volatile data (such as current news reports), come from diverse data suppliers (for instance via RSS). This is also possible in combination with a time-related criterion producing a higher or lower ranking or visualization.

Sorting of the information may be desirable. If data are stored in a relational database, the Altitude Ranking corresponding to the ‘altitude’ will be carried out by means of sorting on a ranking column (or a plurality of columns). This is the case for instance in a travel industry application when hotels in a higher price range or with a greater number of stars must be shown at a higher level for promotion purposes. The Altitude Ranking algorithm can herein ensure that these objects are visualized in a higher shell.

For adjacent layers it is the case that an almost infinite number of shells could in theory be defined and filled. A limited number of layers will preferably be used in practice. If the number of layers in the available space is reduced, this may preferably not then have the result that ‘empty shells’ are created. In this case the Altitude Ranking mechanism will therefore make the ranges which are desired wider or the layers ‘thicker’, so that the whole space remains filled and, irrespective of which shell the user visits (viewing or cruise altitude), data will be available.

Determining the Altitude Ranking of an object can be related to the relevance of the object in general or specifically for the user in question. We distinguish here external ranking and self-ranking types.

In external ranking the relevant object has a value imposed from outside. An object comprising a news report that has just come in shortly before (e.g. via RSS) can for instance acquire a high ranking due to the high topical value or importance. A user will be shown this news report rather than an older report.

Another example of external ranking is when a user has a preference for an object (for instance after visiting an object on a web site), which as a result has a ranking imposed thereon. External ranking can also be dictated by a personal interest profile of the user; in this case we are looking at individual/personal Altitude Ranking.

Independent Altitude Ranking (self-ranking) is a method wherein an intrinsic property of the object itself brings about the ranking. Objects could be assigned a higher ranking depending on the popularity (click behaviour/zoom behaviour) on the basis of the Altitude Ranking algorithm. The consequence hereof is that such an object is in turn seen sooner by more visitors. In this way a natural selection is made and the most interesting/relevant information enters a higher shell and, as it were, surfaces sooner.

A non-limitative example of a possible embodiment of a method according to the present invention is shown in the accompanying drawing. Herein:

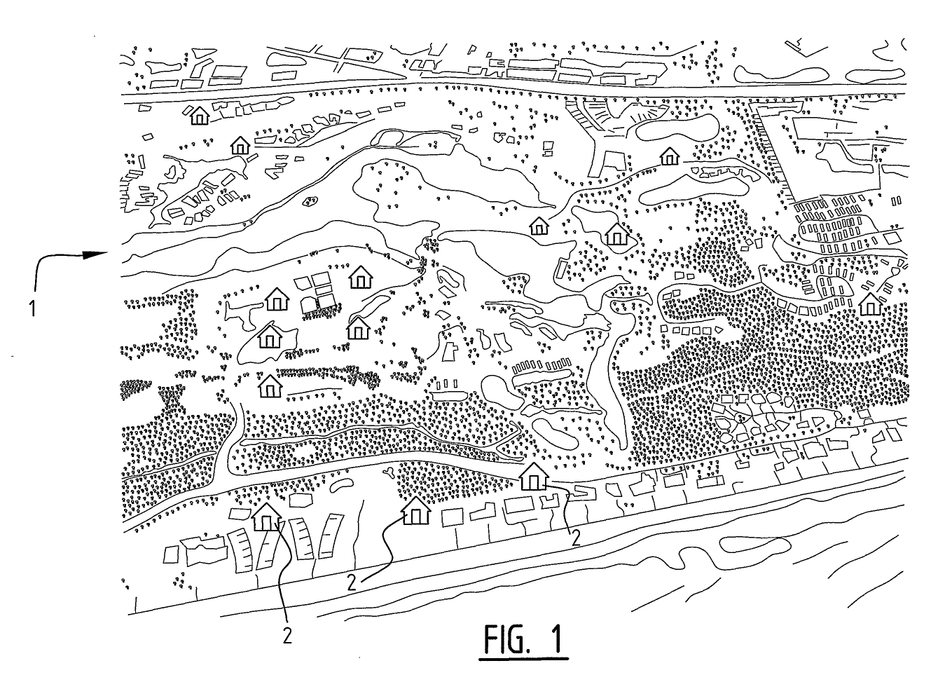

FIG. 1 shows a perspective view of a 3-D virtual environment on the basis of a curved 2-D space (the surface of a globe) in a graphic representation (or interface) with visualizations of individual objects therein.

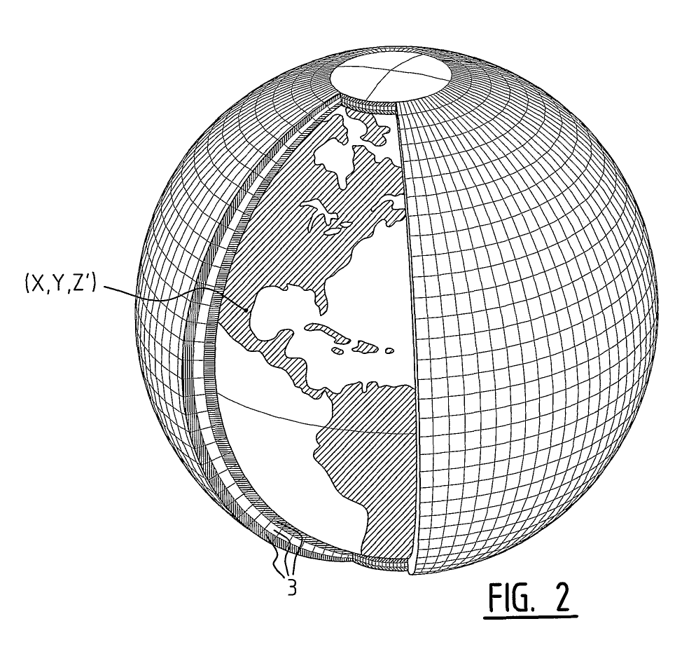

FIG. 2 shows a view of a globe having around it layers, shells or ranges of cruising or viewing altitudes; and

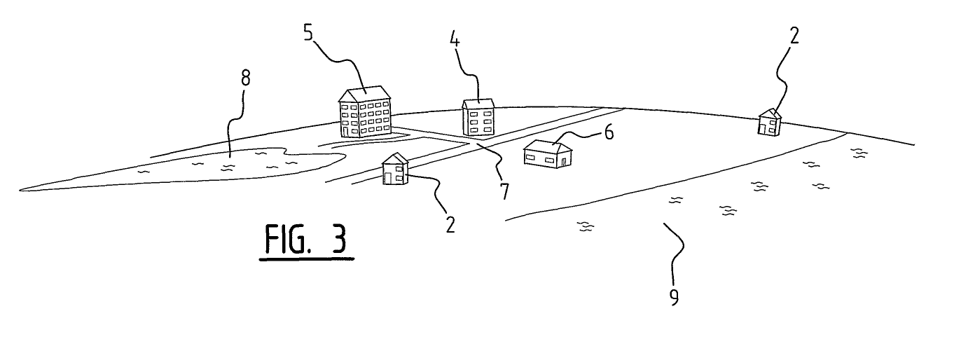

FIG. 3 shows a perspective view of a surface of a globe having thereon several buildings as possible embodiments of objects.

In the embodiment of FIG. 1 of a representation in a graphic interface is shown a landscape 1. As is perhaps shown more clearly in FIGS. 2 and 3, landscape 1 comprises a curvature. Despite the curvature, landscape 1 is designated a 2-D space in the context of the present invention. Landscape 1 does in fact form the basis of a 3-D environment with altitudes above landscape 1. Located at a height above the landscape which is not further defined here there is a viewing point (not shown) from which the—virtual—view of FIG. 1 can be seen.

In the representation of landscape 1 buildings 2 are shown at associated locations (coordinates X, y). Buildings 2 are mainly houses. The houses represent a selection from a larger set of objects, which can for instance include all buildings, companies, houses for sale and so on. The houses are selected for visualization on the basis of a viewing or cruise altitude taken up by a user in the 3-D environment. If the viewing or cruise altitude occupied by the user were to be higher or lower, this altitude can then be located in a higher or lower altitude range or shell 3. This shown in FIG. 2. More expensive or cheaper houses could here be visualized (different altitude of viewing point in higher or lower shell), or visualization of other types of building can hereby be selected by the user. A selection criterion can thus be assigned according to the present invention to each altitude range or to each shell 3.

In the representation of FIGS. 1 and 3 objects are represented as signs, symbols, icons or pictograms. Objects visualized within a shell can still display discernible differences. Houses 2 satisfying the criterion of having to have a garden can thus be visualized in a colour other than houses without garden.

FIG. 3 shows a subset of buildings 2. Because the viewing or cruise altitude is low, many diverse types of building 2 can be visualized. Other objects (to be represented with other pictograms) are however omitted. A three-star hotel 4 and a five-star hotel 5 are shown in the representation of a graphic interface of FIG. 3. The five-star hotel is visualized in larger form although both hotels are made visible, even if both hotels are visualized at the viewing or cruise altitude within a single shell 3. Houses 2 are once again also shown, as is a school 6. A road network 7, a lake 8 and a sea 9 can also be seen. All locations which are or can be linked to an object from a set of objects, which can comprise many more objects than shown here, can be selected by the user by adjusting his/her viewing or cruise altitude or by setting a filter function with search terms and so on. Furthermore, objects from a determined category or which satisfy a first criterion can be further emphasized by enlarged visualization. This is also possible using a colour or another form, pictogram, icon or the like to be selected for visualization. After visiting a web site for the purpose of booking travel, in particular hotels, a user may for instance be confronted in the visualization of the 3-D environment with general pictograms of hotels having a number superimposed thereover (“3” for a three-star hotel and a “5” for a five-star hotel). As has become apparent, the possibilities are in any case numerous.

A possible embodiment of a method according to the present invention is described in the foregoing with reference to the associated drawing. It will however be immediately apparent herefrom that, after examination thereof, diverse additional and alternative embodiments will occur to the skilled person. These additional and alternative embodiments do fall within the scope of protection to the extent they do not depart from the definitions according to the appended claims, in particular claim number 1, or from the essence or spirit of the present invention. It is thus possible within the thus defined scope of the present invention to use diverse types of visualization of objects for different criteria or properties. If for instance an object with a first property within a category or in accordance with a criterion is visualized at a corresponding altitude, an additional distinction can be made within a relevant altitude range or in a shell on the basis of a second property or corresponding criterion in order to visualize different objects in the shell with different colours, pictograms, symbols, icons and so on. It is thus also possible for one, or more than one object in a shell to have different visualizations corresponding to diverse properties. This distinction within one shell or altitude range can be realized using colours, shapes or definition which are then linked to another (non-geographical) object characteristic (e.g. price). An object can be situated in a plurality of shells. It is then preferably also the case here that in a lower-lying shell the altitude of objects decreases, and therefore the relevance. This in turn has the result that more objects are located at a lower level than at a higher level. This can however be reversed. A particular application of the method will be that Altitude Ranking is not determined by commercial motives, wherein this is a method of natural selection. In such an environment the objects can have the same starting level (shell) and, depending on the number of clicks or otherwise indicated ranking, the object can in time rise to a higher level. Because this in turn results in more people taking note of this object, there will be a natural acceleration here. This is a very natural filtering of data. One of the possible applications of Altitude Ranking relates to linking of the Altitude Ranking to the wish of the (commercial) provider of data. When the user or visitor ‘zooms in’ from above, the data in the highest shells will be presented first, whereafter the user will probably orient him/herself toward a visible object with the greatest relevance, i.e. the highest or most noticeable visualization visible at that moment. It will then be desirable to present these objects in the highest possible shell. The number of shells can preferably be determined per situation. Several tens will in practice be sufficient and the overall view will be retained. In addition, it is possible for dynamic layers to be inserted or removed depending on supply, topicality or behaviour of the user. It will be possible to use the application of Altitude Ranking within Real Estate/Estate Agency brokering in order to present houses or other types of object and attract the attention of visitors thereto. It can be possible here for the Altitude Mechanism to be controlled from outside by sending specific location data and a desired altitude from a website to the controlling Altitude Ranking mechanism. This will be the case at the moment someone has selected for instance a house on a house site and clicks further to the virtual globe. The focus then lies on the selected object, while other relevant objects in the environment and shell can automatically become visible. Altitude Ranking can further be utilized within Travel (travel sector) for presenting hotels, houses, camping sites, apartments or other types of data related to Travel, with criteria such as degree of occupancy, popularity, risk areas, areas of interest and so on. News objects (which are received for instance via an RSS feed and/or are made available from a database) can be shown in a related shell subject to news value and/or topicality. Information suppliers (such as for instance Yellow page-like data sets) can utilize the Altitude Ranking for timely visualization of the most relevant information for the searching visitor. Governments can apply Altitude Ranking in the presentation and making available of diverse data, including dangerous objects (hazard map), disaster plans, zoning plans or current events on the map.

The present invention is not limited to the above described embodiment thereof; the rights sought are defined by the following claims.

1-20. (canceled)

21. A method of visualizing information about objects in a graphical environment for the benefit of a user, comprising the steps of:
a) providing a substantially 2-D space with a plurality of separate locations;
b) providing a set of objects, wherein each set of objects includes a plurality of objects;
c) linking each of the objects of the set of objects in the 2-D space to an associated location in the 2-D space;
d) representing a 3-D virtual environment defined by the 2-D space; and
e) accentuating and representing the objects of the set of objects on the basis of altitudes in the 3-D virtual environment relative to the 2-D space.

22. The method as claimed in claim 21, wherein the 2-D space is curved.

23. The method as claimed in claim 22, wherein the 2-D space comprises at least a part of a globe.

24. A method of visualizing information about objects in a graphical environment for the benefit of a user, comprising the steps of:
a) providing a substantially 2-D space with a plurality of separate locations;
b) providing a set of objects, wherein each set of objects includes a plurality of objects;
c) linking each of the objects of the set of objects in the 2-D space to an associated location in the 2-D space;
d) representing a 3-D virtual environment defined by the 2-D space; and
e) accentuating and representing a respective symbol corresponding to objects of the set of objects, wherein the symbol is one of a sign, an icon and a pictogram.

25. The method of claim 21, wherein the step of accentuating comprises comparing a property of one of the objects to a criterion and adjusting a visualization of the representation of the object in accordance with the degree to which the property satisfies the criterion.

26. The method as claimed in claim 25, further comprising the step of selectively increasing or decreasing the altitude of the representation of the relevant object in the 3-D virtual environment on the basis of the degree of correspondence of the property to the criterion.

27. The method of claim 21, further comprising the step of dividing the altitude in the 3-D virtual environment into at least two ranges or shells.

28. The method of claim 27, further comprising the step of representing an object substantially only if the altitude of an object, after accentuation, lies in one of the selectable ranges.

29. The method as claimed in claim 27, further comprising the step of providing adjustability of the viewing or cruise altitude of a viewing point in the 3-D virtual environment.

30. The method as claimed in claim 29, wherein adjustment of the viewing or cruise altitude is related to selection of at least one of the ranges or shells.

31. The method as claimed in claim 25, further comprising the step of selectively providing a color to the representation of one of the objects in the 3-D virtual environment on the basis of the degree to which the property satisfies the criterion.

32. The method as claimed in claim 25, further comprising the step of providing an input option, wherein the criterion can be entered by a user via the input option.

33. The method as claimed in claim 32, further comprising the steps of entering at least one criterion in advance, and storing the at least one criterion in a profile or deriving the at least one criterion from previous behavior of the user.

34. The method as claimed in claim 25, further comprising the step of providing the criterion on the basis of at least one intrinsic property of the object.

35. The method as claimed in claim 25, further comprising the step of modifying the criterion on the basis of sponsoring of the object by a party with an interest in the object.

36. The method as claimed in claim 25, further comprising the step of providing an adjustability of the degree of correspondence on the basis of popularity of an object and more prominent representation thereof.

37. The method as claimed in claim 29, further comprising the step of representing the intrinsic properties of one of the objects in a degree of detail, wherein the degree of detail is related to the cruising or viewing altitude.

38. A device for visualizing information about objects in a graphical environment for the benefit of a user, wherein the device includes a computer readable medium having stored thereon instructions which, when executed by a processor, cause the processor to:
a) provide a substantially 2-D space with a plurality of separate locations;
b) provide a set of objects, wherein each set of objects includes a plurality of objects;
c) link each of the objects of the set of objects in the 2-D space to an associated location in the 2-D space;
d) represent a 3-D virtual environment defined by the 2-D space; and
e) accentuate and represent the objects of the set of objects on the basis of altitudes in the 3-D virtual environment relative to the 2-D space.

39. A computer readable medium having stored thereon instructions which, when executed by a processor, cause the processor to.
a) provide a substantially 2-D space with a plurality of separate locations;
b) provide a set of objects, wherein each set of objects includes a plurality of objects;
c) link each of the objects of the set of objects in the 2-D space to an associated location in the 2-D space;
d) represent a 3-D virtual environment defined by the 2-D space; and
e) accentuate and represent the objects of the set of objects on the basis of altitudes in the 3-D virtual environment relative to the 2-D space.
